(19) United States
(12) Patent Application Publication
(10) Pub. No.: US 2008/0301169 A1
(43) Pub. Date: Dec. 4, 2008

(54) ELECTRONIC APPARATUS OF PLAYING AND EDITING MULTIMEDIA DATA

(76) Inventor: Tadanori Hagihara, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/754,958

(22) Filed: May 29, 2007

(51) Int. Cl. G06F 17/30

(52) U.S. Cl. 707/102

(57) ABSTRACT

To edit and play multimedia information, an electronic apparatus includes a storage device, an editing interface and a player. The storage device is used for storing content entities, e.g. video files, audio files, image files, etc. The editing interface provides a user to select a portion of one or more content entities and the selection result are stored in indicator entities. Such indicator entities do not store original multimedia information, but only stores indicators for recording which portions of content entities are selected. When such indicator entities are requested to be played, the player retrieves and plays indicated portions as indicated by indicators stored in the indicator entities. The multimedia information is not re-encoded during the editing. Still, the electronic apparatus is capable of providing both editing and playback function.

### BACKGROUND

1. Field of the Invention

The present invention relates to an electronic apparatus with editing and playback function and more particularly relates to an electronic apparatus which provides users with a flexible way to edit and play multimedia data.

2. Description of the Prior Art

Mobile phones have more and more functions under rapid developments. Due to battery capacity and other considerations, however, there are limited resources, e.g. memory storage and computation power, in a mobile phone compared with other electronic apparatuses like laptop computers. On the other hand, mobile phones are much closer to human life. The needs for more colorful and interesting user experience are even higher than that for laptop computers.

Consequently, various improvements of mobile phones appear in the market. For example, years ago, people are satisfied with black/white screens but color screens are now a basic requirement for today's mobile phones. While multimedia has becomes basic requirements, editing multimedia in a mobile phone or other handheld devices is still luxury because it may consume large of computation power and storage. For example, it is one thing to play MP3 files in a mobile phone but quite another to edit an MP3 file on a mobile phone because it takes, in addition to decoding MP3 to raw data, complicated operations to encode edited results. It is difficult to edit audio files and even more difficult to edit video files on a normal mobile phone. Usually, the multimedia files are downloaded to a personal computer and complicated software is used for editing multimedia data and encoding edited results with complex encoding algorithms, e.g. motion detection and other predictions optimization. Then, edited results are uploaded back to a mobile phone. If a user just wants to have a personal ring tone or a screen saver animation, it is too inconvenient for user to do so on a normal mobile phone, particularly in a low-end mobile phone. Of course, an expensive mobile phone with strong computation power and storage may solve the problem in some aspects, but it is not good enough. Therefore, if a more convenient design to edit and play multimedia data with few resource requirements can be constructed, such design would bring great technical and convenient benefits to users by providing them better and more convenient mobile phones. If such design can also be applied in other electronic apparatuses, it can be even better.

### SUMMARY

According to an embodiment of the present invention, an electronic apparatus is designed for editing and playing multimedia data. The electronic apparatus includes a storage device, an editing interface and a player. The storage device is used for storing content entities, e.g. video files, which carry original multimedia information like video, audio, images, etc. The editing interface is provided so that users may compose one or more than one indicator entities, which may be in file format or in other formats. These indicator entities do not store original multimedia information but instead stores at least one indicator that is used for indicating a portion of one content entity or portions of several content entities.

The player is designed for playing the content entities and the indicator entities. By reference to the indicators stored in the indicator entities, the player retrieves selected portions of original multimedia information stored from one or more than one content entities. The multimedia information retrieved is then played after certain decompression or adding certain effects also indicated in the indicator entity to be played.

The indicator entity may be associated or connected to various events of the electronic apparatus like incoming calls, incoming messages and screen saving modes. Such indicator entities are used as ring tones, animations, background images, etc. With such approach, there is no need to store a complete copy of selected multimedia sources. In fact, more than one multimedia sources can be edited together to provide an even more color user interface while keeping such under certain limitations of computation power and storage capacity. Such features may also be applied in other electronic apparatuses and would particularly significant effects for handheld devices with limited resources.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an exemplary mobile phone as a preferred embodiment according to the invention;

FIG. 2 is a diagram illustrating an exemplary edit screen of an editing interface;

FIG. 3 is a flowchart showing exemplary procedures for generating indicator entities;

FIG. 4 is a flowchart showing exemplary procedures for modifying settings of an indicator entity; and

FIG. 5 is a flowchart showing exemplary procedures of playing an indicator entity.

### DETAILED DESCRIPTION

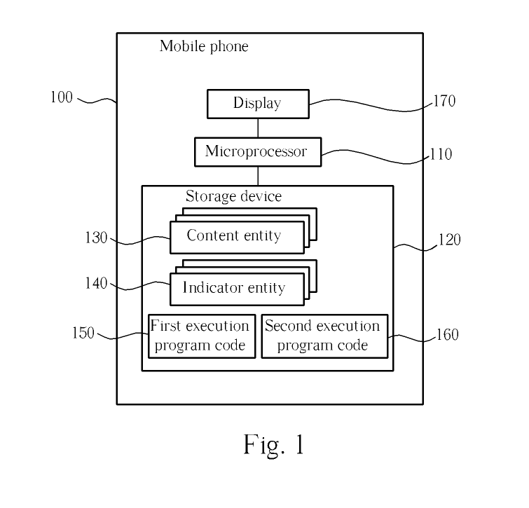

FIG. 1 is a diagram which illustrates a mobile phone 100 as a preferred embodiment according to the invention. The mobile phone 100 is an example of electronic apparatus that provide users to playback and/or edit multimedia data. Other types of electronic apparatuses may include, but are not limited to, digital cameras, handheld game consoles and PDAs. With the following explanation, persons skilled in the art will understand that the invention can be implemented with any electronic apparatus with multimedia editing and playback functions but is particularly useful for electronic apparatuses with limited memory space and computation power.

The mobile phone 100 includes a display 170, a microprocessor 110 and a storage device 120. Network interface for providing communicating capability including corresponding decoders, demodulators, encoders, modulators and antennas as well as other components, e.g. keypads, cameras, touch panels, are not illustrated and explained in detail here for the matter of simplicity. Persons skilled in the art, however, will know how to incorporate the following described inventive features in any known architecture of multimedia mobile phones. For example, the microprocessor 110 may be implemented as one or more than one integrated chips, e.g. a graphical accelerator chip accompanied by a processor. The microprocessor 110 may also refer to processors of different levels of computation power, e.g. from a controller to a GHz multi-cores processor. With the microprocessor 110, program codes written as firmware or software may be coded and executed by the microprocessor 100 to perform certain functions. In addition, within the microprocessor 110 or outside the microprocessor 110, specifically designed decoding and/or encoding and/or other hardware circuits may also be disposed so that these hardware circuits may co-work with corresponding software to perform various multimedia and communication functions, e.g. MPEG decoding, audio recording, communication network layers, etc. For example, program codes may be coded to instruct the microprocessor 110 to provide users with a man machine interface to handle input from keypads, touch panels and output audio via speakers and video output via the display 170 as shown in FIG. 1. In other words, the following described inventive features may be implemented with various hardware circuits, software codes and/or their combinations.

The storage device 120 may also be implemented with various memory types, e.g. flash memory devices and/or mini hard disks. In this example, storage device 120 contains content entities 130, indicator entities 140, first execution program codes 150 and second execution program codes 160. The content entities 130 may refer to a file, an entry in a database, a directory that includes several files or any data structure as a unit for storing original multimedia information, e.g. video, audio, image and/or their combinations. The original multimedia information stored in content entities 130 may be raw data or compressed with various compression algorithms, e.g. MPEP, JPEG, MP3, etc. Instead of storing the original multimedia information, the indicator entities 140 store indicators and related data. Each indicator may be a data structure that indicates at least one portion of a content entity 130. For example, an indicator may refer to 5:30 (5 minutes 30 seconds) to 6:20 (six minutes 20 seconds) of a video file “MovieX.avi” and stored as “MovieX.avi, 5:30, 6:20.” In another example, an indicator may refer to an area, e.g. a set of coordinates values (30, 50)-(70, 110), of an image file. Moreover, an indicator entity, which may be a file or an entry in a database or in any data structure format, may contain a plurality of indicators that indicate portions of the same types of content entities or different types of content entities. In an example of the case of containing indicators for different types in an indicator entity, the indicators may refer to different segments of video clips of a video file or of video files. In anther example of the case of containing indicators of different types in an indicator entity, a first indicator may refer to a segment (or segments) of an audio files for providing audio source and a second indicator may refer to a segment (or segments) of a video file or an image file for providing visual source. With indication of such indicator entities, it is possible to combine various media sources to be dynamically synthesized into a ring tone, a screen saver animation or any other multimedia representation without actually decompressing, compressing and/or concatenate segments of multimedia contents, which may need high computation power and/or large storage size in traditional way. With such, even a handheld device with limited computation power and memory capacity can be used for composing and editing multimedia files.

In addition to the content entities 130 and the indicator entities 140, the storage device 120 also contains the first execution program code 150 and second execution program code 160, which can be executed by the microprocessor 110. The first execution program code 150 are illustrated here for representing corresponding codes for constructing an editing interface and the second execution program code 160 are illustrated here for representing corresponding codes for constructing a player. As mentioned above, what can be implemented in software codes or firmware codes, for persons skilled in the art, may also be implemented with equivalent hardware circuits or with software cooperating with hardware circuits. For example, a MPEG decoder hardware circuit for performing complex decoding algorithms may be implemented in a mobile phone application. Related software, for providing operating interface, may be designed for instructing the MPEG decoder hardware circuit which video files to be decoded and how decoded results appear before users. The editing interface is provided so that a user may compose indicator entities as mentioned above. The player can also be used for a user to play appointed multimedia data, i.e. content entities.

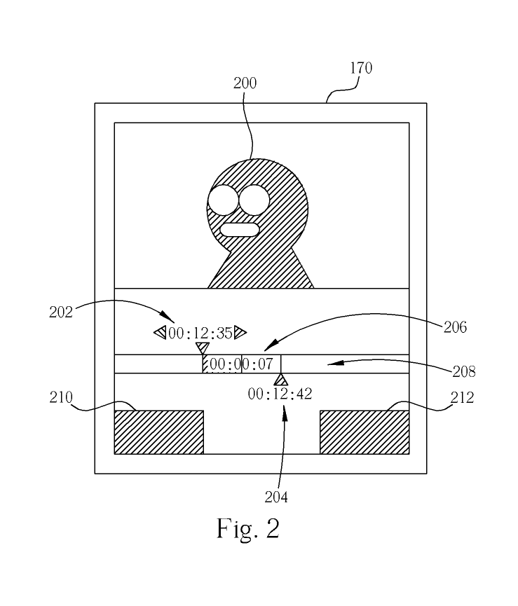

FIG. 2 is an exemplary edit screen 200 of the editing interface for a user to compose indicator entities 140 from content entities 130. Those of average skill in this art no doubt understand that many variations to the man machine interface (MMI) illustrated in FIG. 2 are possible while retaining the spirit of the present disclosure. The display 170 shown in FIG. 1 is used for displaying one or more of the content entities 130 to the user via the edit screen 200 acting as a man machine interface. The display 170 can be an LCD panel that is typically used for mobile phones. The image area of the edit screen 200 previews the content of a selected content entity. The time line 208 indicates a relative length of the selected content entity with respect to a currently selected (i.e., defined) start time indicator 202 and stop time indicator 204 as timestamps. Note that in FIG. 2 the user interface (UI) selected start time indicator and stop time indicator 202,204 are examples of indicators stored in indicator entities 140. A time length (i.e., play interval) indicator 206 shows the defined portion of the selected content entity. A confirm button 210 and a done button 212 are utilized for setting (i.e., confirming) the start time indicator 202 and the stop time indicator 204. Such interface may also be used for editing multiple video files, audio files with minor modifications. It is not to be explained here in further details how to render windows on the display 170 or how to receive inputs of a user because persons skilled in the art may adopt various schemes according their requirements and there are many books discussing how to implement a graphical interface.

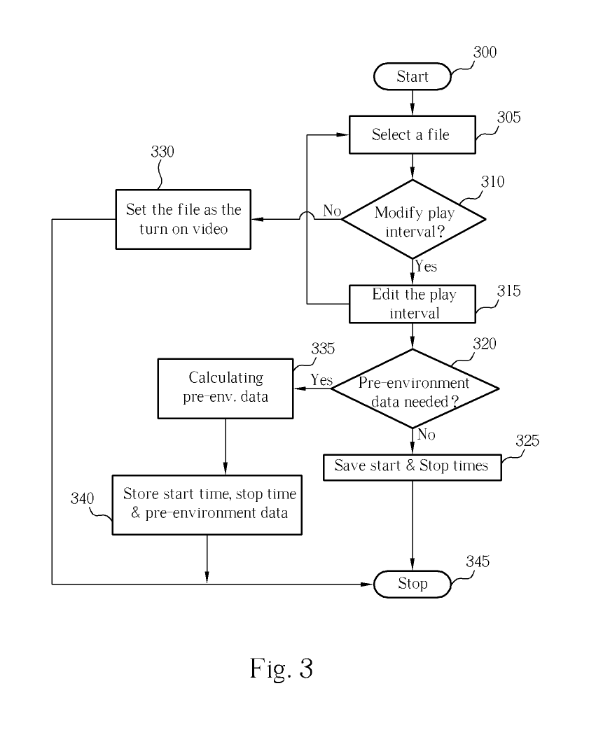

FIG. 3 is a flowchart showing exemplary procedures of the editing interface for composing an indicator entity. The flowchart, which may be implemented to equivalent software or hardware or their combinations, includes the following steps:

Step 300: Start.

Step 305: The user selects a media file.

Step 310: Modify the play interval (i.e., the defined position of the media file 130)? If yes, go to step 315. If no, go to step 330.

Step 315: Edit the play interval to define a portion of the media file 130.

Step 320: Is a pre-environment needed? If yes, go to step 335. If no, go to step 325.

Step 325: Store (i.e., save) the start and stop time 140. Go to step 345.

Step 330: Set the second media file 130 as the turn-on-video. Go to step 345.

Step 335: Calculate the pre-environment data.

Step 340: Store the start time and stop time 140 and the pre-environment data to the storage device 120.

Step 345: Stop.

Please continue referring to FIG. 3. Step 300 begins the flow for setting a portion of the media file to be played on the mobile phone 100. In step 305 the user selects the media file that has been previously stored on the storage device 120. Step 310 allows the user to decide if the selected media file will be edited such that the play interval for playing the selected media file is adjusted from its original play interval being from the beginning of the media file to the end of the media file. In other words, the user is allowed to set a subset of the original second media file 130 as the play interval section that is played by the mobile phone 100. If the user decides to allow the media file to remain untouched then step 330 is performed and the flow proceeds to step 345 where it terminates. If the user selects to edit the playing play interval of the media file then step 320 is followed wherein it is determined if a pre-environment data will be necessary for the given selected media file. The pre-environment data refer to any metadata necessary during decoding a multimedia file. For example, there are P-frames and I-frames in an MPEG file. A frame in an appointed timing may be a P-frame, which means that it needs information from previous frames to decode the appointed frame. The case is the same for MP3 or other multimedia compressed files. If the pre-environment data is required by the defined portion of the currently selected media file then step 335 is executed, the pre-environment data is generated, and then in the subsequent step 340 the pre-environment data along with the user selected start and stop times are stored in the storage device 120. More specifically, when the pre-environment data is needed, the step must perform a seeking operation to find a reference data within the media file to generate the desired pre-environment data and storing the pre-environment data in the storage device 120 so that later when playback of the defined portion of the media file corresponding to the play interval requires the found reference data within the media file but this reference data is not within the media file as delimited by the start and stop time 140. In the other case where the media file does not require a pre-environment data to be generated, the flow goes from step 320 directly to step 325 where it stores only the necessary start and stop times to the storage device 120. At this point, regardless of the need for the pre-environment data, both legs of the flow proceed to step 345 whereby the flow is terminated.

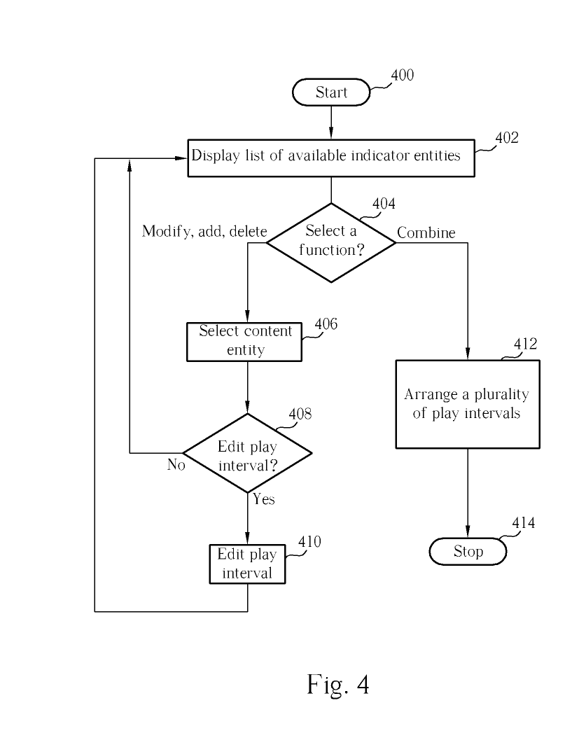

FIG. 4 is a flowchart illustrating exemplary procedures for modifying an indicator entity.

Step 400: Start.

Step 402: Display the list of available indicator entities.

Step 404: Select a function of: modifying the play interval of an indicator entity, or setting a new play interval to an indicator entity, or deleting a play interval from a previously selected indicator entity. Go to step 406 for when options to: modify, add or delete, are selected. Additionally, this step offers a combine option for overlapping various indicator entities. Go to step 412 when the combine option is selected.

Step 406: Select a content entity to be processed;

Step 408: Edit the play interval? If yes, go to step 410. If no, go to step 402.

Step 410: The play interval is edited using the MMI/UI of the present disclosure. Go to step 402.

Step 412: Arrange a plurality of play intervals corresponding to available indicator entities to define the playback of the turn-on video.

Step 414: Stop.

Step 400 begins the process flow. In the next step 402, the user is presented with a list of currently available indicator entities, a source data list, from which they can select at least one to be processed. In step 404 selection functions according to this embodiment are offered to the user as: modifying the existing play interval, or adding a new play interval corresponding to a content entity, or deleting a play interval from a previously selected content entity, or using the combine option for combining various play intervals corresponding to available content entities to define a multi-source file. For example, the content entities selected may include video files and audio files. The user can select the combine option to arrange play intervals for overlapping playback of video files and audio files, concatenating play intervals of video files or concatenating play intervals of audio files. In short, the playback of the turn-on video can be programmed according to the preferences of the user. That is, in step 412, the user can freely arrange the playback of these defined indicator entities using the MMI. Step 404 also provides for modifying of the start and stop times 140 whereby the play interval for a given indicator entity is adjusted. In this step, it is also possible for the user to remove a play interval (i.e., a start and stop time) thereby returning the play interval for the given indicator entity to be the entire length of the original content entity. The user can also add new play interval to a selected content entity for defining a new first media file.

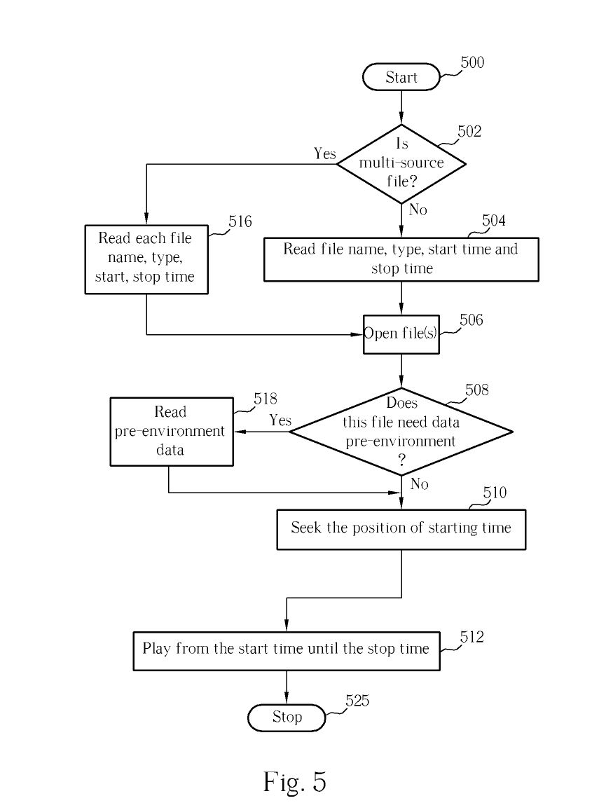

FIG. 5 is a flowchart showing a method for playing a portion of an indicator entity.

Step 500: Start.

Step 502: Is this a multi-source file? If yes then go to step 516. If no, then go to step 504.

Step 504: Read the file name, file type, and start time and stop time associated with a second media file 130.

Step 506: Open the second media file(s) 130.

Step 508: Does the second media file(s) 130 require a pre-environment data? If yes, go to step 518. If not, then go to step 510.

Step 510: Seek the second media file(s) 130 for the starting position of a first media file based on the start time loaded in step 504.

Step 512: Play the second media file(s) 130 from the start time until the stop time. Go to step 525.

Step 516: Read the file name, file type, start time, and stop time associated with each second media file 130. Go to step 506.

Step 518: Read the pre-environment data. Go to step 510.

Step 525: Stop.

The flow of FIG. 5 is described in greater detail below. In step 500, the flow begins. Next, in step 502, if the file to be played requires several, or more than one, source, such as an audio or video source, then go to step 516 to read each of the needed sources. For example, if the step 412 concatenates two video files to define a multi-source file. The playback of the multi-source file requires both video files. After all of the information, such as the file name, the file type, the start time and the stop time associated with each needed second media file 130, stored in the setting associated with the playback of the multi-source file is read, please continue to step 506. However, if the file to be played requires a single source, then go to step 504. In step 504, the file name, the file type, the start time and the stop time associated with a needed second media file 130 are read. In step 506, the needed second media file(s) 130 is opened according to the read file name(s). Then, step 508 checks if the opened second media file(s) 130 requires a pre-environment data according to the read file type(s). If a pre-environment is needed then reading a pre-environment data corresponding to reference data required for playing the defined portion of the second media file(s) 130, the reference data being within the second media file(s) 130 but not within the defined portion of the second media file(s) 130. Therefore, it is necessary that the pre-environment data be read in step 518 and further utilized in step 512 to facilitate the playing to the portion of the second media file(s) 130 (i.e., the first media file). Before step 512 is performed, step 510 is activated to seek the second media file(s) 130 for the starting position of the first media file based on the start time loaded in step 504. Then, step 512 plays the first media file(s) according to the play interval delimited by the start and stop times 140 and finally the flow terminates with step 525. Please note that the second media file 130 can be a video file or an audio file and that the step of playing the second media file(s) 130 from the start time (step 512) can include displaying effects, such as on or more types like: fade in, fade out, text overlay, and text scrolling, before or after the second media file(s) 130 is played according to the defined play interval. These effects are examples only and in no way indicate a limitation of the present disclosure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic apparatus for editing and playing multimedia data, comprising:
a storage device for storing content entities for carrying original multimedia information;
an editing interface for a user to compose an indicator entity, wherein the indicator entity does not store the original multimedia information but stores at least one indicator for indicating at least one selected portion of at least one content entity; and
a player for playing the content entities and the indicator entity, wherein the player retrieves and plays the selected portion from corresponding content entity according to the indicator stored in the indicator entity when the indicator entity is requested to be played.

2. The electronic apparatus of claim 1, wherein the editing interface associates the indicator entity to an event of the electronic apparatus and the player is triggered to play the indicator entity if the event occurs.

3. The electronic apparatus of claim 2, wherein the event is an incoming call, the content entities comprises a music file, and the indicator of the indicator entity indicates a portion of the music file to be played as a ring tone.

4. The electronic apparatus of claim 2, wherein the event is an incoming short message, the content entities comprises an image file, and the indicator indicates a portion of the image file to be rendered to respond the incoming short message.

5. The electronic apparatus of claim 2, wherein the event is starting a screen saving mode, the content entities comprises a video file, and the indicator indicates a portion of the video file to be played during the screen saving mode.

6. The electronic apparatus of claim 2, further comprising: a wireless interface for establishing a connection with an external electronic apparatus, wherein the player provides a multimedia interface for the user to operate the electronic apparatus and there are a plurality of indicator entities, each indicator entity corresponding to one event in the multimedia interface.

7. The electronic apparatus of claim 6, wherein the electronic apparatus is a mobile phone.

8. The electronic apparatus of claim 1, wherein the indicator further specifies an effect to be applied on the selected portion of corresponding original multimedia information.

9. The electronic apparatus of claim 1, wherein the indicator entity further stores metadata for decoding the selected portion.

10. The electronic apparatus of claim 9, wherein the metadata are related frames necessary for decoding the selected portion of one video file.

11. The electronic apparatus of claim 10, wherein the video file is a MPEG file.

12. The electronic apparatus of claim 1, wherein the player suppresses output when the player decodes the content entity indicated by the indicator until the player the selected portion is decoded.

13. The electronic apparatus of claim 1, wherein the content entities are video files and the editing interface provides a preview screen showing a frame at each appointed timing for the user to select a starting timestamp and an ending timestamp of one video file and the indicator stored in the indicator entity comprises the starting timestamp and the ending timestamp.

14. The electronic apparatus of claim 1, wherein the content entities are music files and the editing interface provides a scroll bar for the user to select a starting timestamp and an ending timestamp of one music file and the indicator of the indicator entity comprises the starting timestamp and the ending timestamp.

15. The electronic apparatus of claim 1, wherein the original multimedia information is stored in a compressed format in the content entities and decompressing the content entities takes less processing than compressing.
